(19) United States
(12) Patent Application Publication
(10) Pub. No.: US 2024/0146683 A1
(43) Pub. Date: May 2, 2024

(54) INFORMATION PROCESSING METHOD AND APPARATUS, TERMINAL, AND STORAGE MEDIUM

(71) Applicant: Beijing Zitiao Network Technology Co., Ltd., Beijing (CN)

(72) Inventors: Liaoyuan NING, Beijing (CN); Cong WANG, Beijing (CN); Xinru ZHANG, Beijing (CN); Guangyu ZHANG, Beijing (CN); Geliang TIAN, Beijing (CN); Ying XIAO, Beijing (CN)

(21) Appl. No.: 18/565,940

(22) PCT Filed: Jul. 22, 2022
(86) PCT No.: PCT/CN2022/107353

§ 371 Date: Nov. 30, 2023

(30) Foreign Application Priority Data
Jul. 23, 2021 (CN) 202110838723.9

(51) Int. Cl. H04L 51/42; G06Q 10/10; H04L 51/02

(52) U.S. Cl. CPC H04L 51/42; G06Q 10/103; H04L 51/02

(57) ABSTRACT

Disclosed are an information processing method, apparatus, terminal, and storage medium. An information processing method includes: determining, in response to inputting first information of a target object by a current user, a first information identifier of the first information based on at least one of the target object, information type of the first information, and the current user; and sending a first message derived based on the first information to at least one first target group; wherein the first target group is a group determined from among a set of groups based on the first information identifier. In the embodiments of the disclosure, the first target group is determined based on the first information identifier, eliminating a need for the user to specify the first target group.

### CROSS-REFERENCE TO RELATED APPLICATION(S)

This application claims the benefit of Chinese Patent Application No. 202110838723.9 titled “Information processing method and apparatus, terminal, and storage medium” filed Jul. 23, 2021, which is incorporated herein by reference in entirety.

### FIELD

Embodiments of the disclosure generally relate to computer technologies, and more particularly, relate to an information processing method, an apparatus, a terminal, and a storage medium.

### BACKGROUND

When processing an internal project of an organization, it is always needed to send project-related information to a corresponding group for discussion. A usual practice is that a user sends a message in an input box of a pre-created project group; sometimes, the project is associated with a plurality of groups, so that the user needs to repetitively send the same message to different groups.

### SUMMARY

The disclosure provides an information processing method, an apparatus, a terminal, and a storage medium.

The disclosure adopts a technical solution infra.

In some embodiments, the disclosure provides an information processing method, comprising:
determining, in response to first information of a target object inputted by a current user, a first information identifier of the first information based on at least one of the target object, information type of the first information and the current user; and
sending a first message derived based on the first information to at least one first target group;
wherein the first target group is a group determined from among a set of groups based on the first information identifier.

In some embodiments of the disclosure, the disclosure provides an information processing apparatus, comprising:
a determining unit configured to determine, in response to first information of a target object inputted by a current user, a first information identifier of the first information based on at least one of the target object, information type of the first information and the current user; and
a sending unit configured to send a first message derived based on the first information to at least one first target group;
wherein the first target group is a group determined based on the first information identifier from among a set of groups.

In some embodiments, the disclosure provides a terminal comprising: at least one memory and at least one processor;
wherein the memory stores program codes, and the processor is configured to invoke the program codes stored on the memory to perform the method noted supra.

In some embodiments, the disclosure provides a computer-readable storage medium having program codes stored thereon, which, when executed by a computer, cause the computer to perform the method noted supra.

In some embodiments of the disclosure, after the user inputs the first information, a first information identifier of the first information is generated, and a first target group receiving the first message is determined based on the first information identifier. In this way, after the user inputs the first information of the target object, there eliminates a need to specify the first target group and a need for the user to repetitively send the first information to various groups, thereby avoiding potential occurrence of group privacy and permission issue, and thus information synchronization between multiple groups may be achieved without joining the groups.

### BRIEF DESCRIPTION OF THE DRAWINGS

Through the following detailed description of the example embodiments of the disclosure with reference to the accompanying drawings, the above and other objectives, features, and advantages of the disclosure will become more apparent. Throughout the accompanying drawings, like or similar reference numerals represent same or identical elements. It is understood that the drawings are schematic, so that the components and elements are not drawn with exact scales.

FIG. 1 is a flow diagram of an information processing method according to embodiments of the disclosure.

FIG. 2 is a schematic diagram of an association relationship between communication groups according to embodiments of the disclosure.

FIG. 3 is a diagram of an information sending path according to embodiments of the disclosure.

FIG. 4 is a diagram of mapping relationship according to embodiments of the disclosure.

FIG. 5 is a structural schematic diagram of an electronic device according to embodiments of the disclosure.

### DETAILED DESCRIPTION OF EMBODIMENTS

Hereinafter, embodiments of the disclosure will be described in more detail with reference to the accompanying drawings. Although some example embodiments of the disclosure have been illustrated in the drawings, it is understood that the disclosure may be implemented in various forms, not limited to the example embodiments depicted herein; instead, provision of these example embodiments is intended for a more thorough and comprehensive understanding of the disclosure. It is understood that the accompanying drawings and example embodiments provided herein are only for illustrative purposes, not for limiting the scope of protection of the disclosure.

It is understood that the various steps recited in method embodiments of the disclosure may be performed sequentially and/or concurrently. In addition, the method embodiments may comprise additional steps and/or omit some steps illustrated. The scope of the disclosure is not limited thereto.

The term “comprise” and its variants used herein refer to an open inclusion, i.e., “including, but not limited to.” The term “based on” refers to “at least partially based on.” The term “one embodiment” refers to “at least one embodiment”; the term “another embodiment” refers to “at least one further embodiment”; and the term “some embodiment” refers to “at least some embodiments.” Relevant definitions of other terms will be provided in the description infra.

It is noted that concepts such as “first” and “second” indicated herein are used only for distinguishing different apparatuses, modules, or units, not intended for limiting the sequence of the functions executed by such apparatuses, modules or units or limiting their mutual dependencies.

It is noted that the modifier “a/an” indicated herein is illustrative, not limitative. Those skilled in the art would understand that except otherwise indicated in the context, this modifier shall be understood as “one or more.” The term “A and/or B” indicated herein represent three parallel circumstances: A; B; and A and B, i.e., at least one of A and B.

The names of interactive messages or information between a plurality of components in the embodiments of the disclosure are only for illustrative purposes, not for limiting the scope of such messages or information.

Hereinafter, the solutions provided in the embodiments of the disclosure will be described in detail.

In a scenario of processing a project within an enterprise, updating of project information always occurs. After the project information has been updated, members interested in the project should be notified, which requires accessing a group for message sending, for which a user updating the project information is required to join the group and thus a permission issue potentially arises. In addition, it is likely that more than one group is interested in the project, so that information synchronization is needed between different groups. Therefore, in some technologies, a user should join all communication groups and directly send a message to all of the groups via a message sending interface, or create a group list and send the message uniformly to group heads of respective communication groups via a message interface of a server to inform the group heads to send the message to their respective groups. The two approaches noted supra require manual maintenance of the group list and require the sender to join all group chats, so that they are demanding on the sender. In addition, there may be permission issues for the sender.

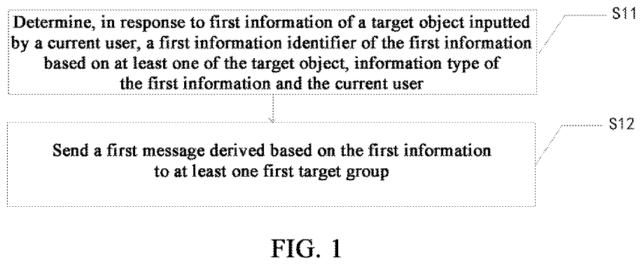

FIG. 1 illustrates a flow diagram of an information processing method according to embodiments of the disclosure, comprising steps of:
S11: determining, in response to first information of a target object inputted by a current user, a first information identifier of the first information based on at least one of the target object, information type of the first information and the current user;
S12: sending a first message derived based on the first information to at least first target group.

In some embodiments, the information processing method may be applied by a client, e.g., an instant messaging client. The target object, for example, may be an internal project or an internal task, and the first information is information associated with the target object. In some embodiments, the first information may refer to project-associated information, and the project may be a research program or a planning scheme. The first information may also refer to task-associated information, and the task for example may be an event to be worked. In some embodiments, the project may include a plurality of tasks. The first information includes an information type. In a case that the first information is project-associated information, the information type may, for example, include at least one of a project tracking record, a project demand and a project report, and the information type of the first information is the project tracking record, the project demand or the project report. In a case that the first information is task-associated information, the information type for example may include: at least one of a task progress, a task objective and a task report, and the information type of the first information may refer to the task progress, the task objective or the task report. The information type of the first information may describe a role of the first information. A first information identifier of the first information is generated based on the target object, the information type of the first information and the current user, and the first information identifier for example may refer to a feature ID of the first information. With the first information identifier being generated, at least one first target group to receive a first message may be determined based on the first information identifier, i.e., in some embodiments of the disclosure, a user may send the first message to a first target group associated with the first message without a need for the user to select a group to send, and there may also exist two or more first target groups. As such, after the current user has inputted the first information of the target object, the first information may be sent to the first target group, whereby information synchronization is realized, eliminating a need for the current user to join each group, respectively, and thusly avoiding potential group privacy and permission issues. In addition, since the first target group is determined based on the first information identifier, the current user needn't know which groups the first information should be sent to. The first message may be generated based on the first information, and the first message may include the first information.

In some embodiments of the disclosure, the information processing method further comprises: determining a second target group associated with the first information; and sending the first message to the second target group. In some embodiments, in addition to being sent to the first target group, the first message is also sent to the second target group, whereby message synchronization between the first target group and the second target group is realized, eliminating a need for the user to manually perform message synchronization between the first target group and the second target group.

In some embodiments of the disclosure, the determining a second target group associated with the first information comprises: determining the second target group based on the first information and/or an input interface where the first information is inputted. In some embodiments, the second target group is not determined based on the first information identifier, but determined based on the first information. For example, the second target group may be determined based on semantics of the first information or based on the input interface where the first information is inputted. In some embodiments, by determining the second target group based on the first information, there eliminates a need for the user to input the first information via the communication interface of the second target group. By determining the second target group based on the input interface of the first information, there eliminates a need for the user to additionally specify the second target group. In a case of determining the second target group based on the first information and the input interface, the first information may be different even if the input interface was the same, whereby an effect of sending a message to different second target groups in a same input interface is achieved.

In some embodiments of the disclosure, the second target group is a group bound with the input interface where the first information is inputted. In some embodiments, the second target group is determined only based on the input interface of the first information. In this case, the input interface may be an information input interface of the second target group, so that the first message may be simultaneously sent to the first target group and the second target group via the information input interface of the second target group, without a need to open the communication interface of the first target group.

In some embodiments of the disclosure, the second target group is a group bound with the information type of the first information. In some embodiments, the second target group is associated with the information type of the first information, and the groups bound with information of different information types may be different. In this case, the second target group may be independent of the input interface where the first information is inputted, i.e., irrespective of where the first information is inputted, so long as the information type of the first information is not changed, it may be sent to the same second target group, whereby an effect of sending a message to the same second target group via different input interfaces is achieved, which facilitates the user to input the first information, without being restricted by the location where the first information is inputted. At this point, the input interface of the first information may be the input interface of any group in a set of groups.

In some embodiments of the disclosure, the sending a first message derived based on the first information to at least one first target group comprises: sending the first information and the first information identifier to a server, so that the server determines the at least one first target group from among the set of groups based on the first information identifier, and sends the first message derived based on the first information to the first target group.

In some embodiments, the first target group may not be determined by an operator of the method according to the embodiments of the disclosure; instead, the determining the first target group and sending the first message are performed by the server based on the first information identifier. In this way, the operator in the embodiments of the disclosure determines the information identifier of the first information, but does not perform the operation of determining the first target group, thereby reducing computing power consumption of the operator in the embodiments of the disclosure, which facilitates application of the method provided in the embodiments of the disclosure on an appliance with relatively low computing power.

In some embodiments of the disclosure, the current user inputs the first information in the information input interface; the information input interface is an interface other than communication interfaces of respective groups in the set of groups. In some embodiments, the information input interface is not communication interfaces of the groups in the set of groups, but may be an interface of a control, e.g., an interface in a mini program. This eliminates a need of inputting the first information in the communication interface and thusly eliminates a need for the user to join a specific group, avoiding the potential permission issue, which may also eliminate a need to remember the first target group and the second target group.

In some embodiments of the disclosure, the current user inputs the first information in the communication interface of a group in the set of groups. In some other embodiments, the first information may be inputted in the communication interface of a group in the set of groups, in which case the communication interface where the first information is inputted may refer to the communication interface of the first target group or of the second target group. In these embodiments, so long as the first information is inputted in the communication interface of a group in the set of groups, it may be sent to the first target group, which may facilitate the user to send the first message to the first target group while keeping a normal communication with group members.

In some embodiments of the disclosure, the determining a first information identifier of the first information based on at least one of the target object, an information type of the first information and the current user comprises: determining types and number of pieces of sub-identifier information included in the first information identifier based on the information type of the first information, the first information identifier including at least one piece of sub-identifier information; and determining contents of the sub-identifier information included in the first information identifier based on at least one of the target object, the type of the first information and the current user.

In some embodiments of the disclosure, the first information identifier includes one or more pieces of sub-identifier information, the sub-identifier information includes type information, and the types and number of pieces of sub-identifier information included in information identifiers of different information types of information may be different. For example, the information identifier of the first information type of information may include two pieces of sub-identifier information, the information identifier of the second information type of information may include three pieces of sub-identifier information, and the information identifier of the third information type of information may also include three pieces of sub-identifier information. However, the types of the sub-identifier information of the information identifier of the second information type of information are not exactly identical to the types of the sub-identifier information of the information identifier of the third information type of information, so that depending on the differences in the types and numbers of pieces of the sub-identifier information, the information identifiers of the information may take on a variety of forms, so that different information identifiers can be identified as much as possible. The sub-identifier information may be classified into an object identifier, an information type identifier, and a user identifier by type, where the object identifier is determined based on the object of the information, the information type identifier is determined based on the information type of the information, and the user identifier is determined based on the user creating the information.

In some embodiments of the disclosure, compositional structures of respective information identifiers corresponding to different information types of information are preset, the compositional structure includes at least one piece of the sub-identifier information, types of respective sub-identifier information in one compositional structure are different, and the compositional structures of the information identifiers corresponding to different information types of information are different. Determining the types and the number of pieces of sub-identifier information included in the first information identifier based on the information type of the first information comprises: determining a compositional structure corresponding to the first information identifier based on the information type of the first information, and determining the type and the number of pieces of the sub-identifier information based on the compositional structure corresponding to the first information identifier.

In some embodiments, the compositional structures of respective information identifiers corresponding to different information types of information describe the number of sub-identifiers and respective types of the sub-identifiers included in respective information identifiers, which may also describe arrangement orders of the sub-identifiers. The compositional structures of the information identifiers of different information types of information may be different. Upon determining the information type of the first information, the compositional structure of the information identifier of this information type of information is obtained, and then based on the composition structure, the number of pieces of the sub-identifier information and the type of respective sub-identifier information included in the first information identifier may be known. In this embodiment, by pre-setting respective compositional structures, the sub-identifier information included in the first information identifier can be promptly determined, which reduces the time and computing power consumed for generating the first information identifier and improves response speed.

In some embodiments of the disclosure, the first target group is associated with at least one of the target object, the information type of the first information and the current user. In some embodiments, the first target group may be pre-bound with the target object, the information type of the first information and the current user. For example, an association attribute may be set for the first target group, and the association attribute includes at least one of the target object, the information type of the first information and the current user. In some embodiments, an association relationship table may be preset, in which the association relationship of the first target group with the target object, the information type of the first information and the current user are set forth. In some embodiments, the first target group may be associated with all of the target object, the information type of the first information and the current user.

In some embodiments of the disclosure, each group in the set of groups has at least one group identifier bound, and there exists a mapping relationship between the group identifier bound with the group and the information identifier of the information. The first target group is determined based on the first information identifier and the mapping relationship. In some embodiments of the disclosure, each group in the set of groups has a group identifier, and there exists a mapping relationship between the group identifier and the information identifier, so that upon acquiring the first information identifier, it may be known whether respective group identifiers are mapped with the first information identifier based on the mapping relationship, and a group corresponding to the group identifier with the mapping relationship serves as the first target group. In the embodiments of the disclosure, each group is provided with a group identifier, and the first information is configured with a first information identifier, so that the first target group is determined directly based on the mapping relationship between the group identifier and the first information identifier, without a need for the user to specify the group receiving the first message. By maintaining the mapping relationship, the user can send the first message to the first target group without a need to identify the first target group, which eliminates a need for the user to join each first target group and eliminates a need for the user to specifically identify the groups to which the first message is to be sent, significantly reducing the user's operation burden.

In some embodiments of the disclosure, the group identifier includes at least one piece of sub-identifier information, and the information identifier of information includes at least one piece of the sub-identifier information; and the mapping relationship is determined based on the sub-identifier information of the group identifier and the sub-identifier information in the information identifier. In some embodiments, the information identifier includes sub-identifier information, and the group identifier includes sub-identifier information, so that a mapping relationship may be established based on common sub-identifier information between the group identifier and the information identifier. For example, if an information identifier includes all sub-identifier information in the group identifier, there exists a mapping relationship between the information identifier and the group identifier. Or, it may be set that if the information identifier includes a plurality of pieces of specific sub-identifier information in the group identifier, there exists a mapping relationship between the information identifier and the group identifier. For example, the group identifier includes: Object Identifier 1, Object Identifier 2, and Information Type Identifier 1. If the information identifier includes the Information Type Identifier 1 and one of the Object Identifier 1 and the Object Identifier 2, there exists a mapping relationship between the information identifier and the group identifier. Or, if the group identifier includes Object Identifier 1, Information Type Identifier 2, and User Identifier 3, then there exists a mapping relationship between the information identifier and the group identifier only when the information identifier includes all of the Object Identifier 1, the Information Type Identifier 2 and the User Identifier 3. In the embodiments of the disclosure, by establishing a mapping relationship between the group identifier and the sub-identifier information in the information identifier, where the sub-identifier information may be classified into the object identifier, the information type and the user identifier, the information-group mapping relationship can be clearly shown based on the sub-identifier information. This association manner is direct and concise, easy for maintenance and extension.

In some embodiments of the disclosure, there exists a mapping relationship between one information identifier and one or at least two group identifiers of groups. In some embodiments, one information identifier may have a mapping relationship with a plurality of group identifiers, so that there may exist a one-to-multiple relationship between the information identifier and the group identifiers; therefore, one piece of information may be sent to multiple groups, eliminating a need for the user to specify the groups to reach.

In some embodiments of the disclosure, there exists a mapping relationship between the group identifier of one group and one or at least two information identifiers. In some embodiments, there may exist a one-to-multiple relationship between the group identifier and the information identifiers, which also indicates that different messages may be received in one group. In this way, one group may receive messages from a plurality of different users, or may receive messages from different objects, or may receive messages of different types, thereby facilitating the user to set the messages to receive dependent on individualized needs.

In some embodiments of the disclosure, the group identifier bound with the group includes a user identifier, and the information identifier includes the user identifier. The set of groups include a first group, and at least one member in the first group has an associated member. The group identifier of the first group includes a user identifier of the associated group. In a case that the first information identifier includes the user identifier of the associated member, the first target group includes the first group.

In some embodiments, the associated member may not be a member in the first group, so that the first message sent by a member not in the first group may be sent to the first group. In this way, the first target group is determined based on the relationship between the member and the associated member, which is thus applicable to a scenario in which there exists a supervision relationship between users or a scenario with a collaborative relationship not limited to a specific project. For example, the members in the first group may be leaders of respective tasks of an internal project, each task having specific operational individuals responsible for the task, and the specific operational individuals being assigned under respective leaders, in which case the leaders need to receive project-related information sent by the operational individuals at any time. As such, with the first group as the leader group, the project-related information from a plurality of different operational individuals may be converged, eliminating a need for the operational individuals to send information to the leader group, which guarantees that in a case of instant information synchronization, information inconsistency does not occur between the leaders and the operational individuals due to the operational individual' failing to send the information to the leaders.

In some embodiments of the disclosure, the at least one member is a superior to the associated member, while the associated member is a subordinate to the at least one member; and the at least one member and the associated member are associated via a superior-subordinate relationship. In some embodiments, a member in the first group is associated with its associated member via the superior-subordinate relationship, and this association relationship may be applicable to intra-enterprise project processing. In some embodiments, the information sent by a subordinate member is sent to the group where the superior is located so as to be viewable by the superior member, which guarantees that the latest news can be accessed to the superior member and facilitates permission management of messages.

In some embodiments of the disclosure, the group identifier bound with the group includes an object identifier and an information type identifier, and the information identifier includes an object identifier and an information type identifier; the set of groups include a second group, the group identifier of the second group including an information type identifier and at least two object identifiers; and in a case that the first information identifier includes at least one object identifier in the group identifier of the second group, the first target group includes the second group.

In some embodiments, the object identifier in the group identifier of the second group may be configured to identify which objects are of interest to the second group, and the information type identifier in the group identifier of the second group is configured to identify which information types of information are of interest to the second group; the object identifier in the first information identifier may be generated based on the target object, and the information type identifier in the first information identifier may be generated based on the information type of the first information; in a case that the first information identifier includes the object identifier and the information type identifier in the group identifier of the second group, the first information is identified as the information of the information type of the object interested by the second group, so that it is needed to send the first message to the second group. It is noted that the group identifier of the second group includes at least two object identifiers, which indicates that the second group may receive information of different objects. By setting the second group, convergence of information of the same information type of multiple objects may be realized, eliminating a need for the user to collect information from different groups.

In some embodiments of the disclosure, the group identifier bound with the group includes a tag identifier, and the information identifier includes a tag identifier. The target object has a corresponding tag, and the first information identifier includes a tag identifier generated based on the tag of the target object. The set of groups includes a third group, and a group identifier of the third group includes a tag identifier. In a case that the first information identifier includes the tag identifier in the group identifier of the third group, the first target group includes the third group.

In some embodiments of the disclosure, the tag may for example be an attribute tag of an object, which may indicate some attributes of the object. With an example that the object is a project, the tag may indicate the leader of the project. For example, Zhang San is simultaneously in charge of multiple projects, all of which projects may be tagged with “Zhang San”. In this way, the information of respective projects in the charge of Zhang San may all be sent to the third group. Setting of the tag identifier may facilitate the user to keep up with the information of a particular type of object, thereby facilitating information collection.

In some embodiments of the disclosure, one object has at least one tag. In some embodiments, one object may have multiple tags. In some embodiments of the disclosure, objects of the same type have a common tag. In some embodiments, the tag may include an object type tag which may be configured to identify a type of an object. Therefore, the objects of the same type may have the same object type tag. The tag facilitates the user to classify an object, and by assigning the same tag to the objects of the same type or the related objects, it facilitates the user to collect the information of the objects of interest.

In some embodiments of the disclosure, the first message includes an entry control for joining the second target group. In some embodiments, the first message may be displayed in a form of a message card, and a button representing the entry control may be displayed in the message card. By triggering the entry control, an application for joining the second target group may be made, which facilitates the user in the first target group to join the second target group as needed, thereby realizing quick group joining to view messages associated with the first message in the second target group.

In some embodiments of the disclosure, the method further comprises: determining a sharing target object in response to a sharing operation, and sending the first message to the sharing target object. In some embodiments, when inputting the first information, another group or communication user may be specified as a sharing target object to which the first information is to be shared in a manner of selecting or inputting. That is, the user may share the first information to another group or communication user based on individualized needs.

In some embodiments, in a case that the information interface where the first information is inputted is the communication interface of a group in the set of groups, the method is performed by a chatbot joined in the group of the set of groups. As such, since the first message is sent via the chatbot, the user needn't join respective groups.

In some embodiments, in a case that the input interface where the first information is inputted is a page of the target object displayed in the mini program, the mini program performs the step of the determining the first information identifier of the first information based on at least one of the target object, the information type of the first information and the current user, and the mini program sends the first message to the first target group via the chatbot joined in the group in the set of groups. In some embodiments, since the first information is inputted in the mini program and the first information identifier is determined by the mini program, there eliminates a need for the user to search for the first target group. In addition, by sending the first message via the chatbot, the potential permission issue can also be avoided.

In some embodiments of the disclosure, in a case that the current user inputting the first information has joined the first target group, the first message is sent in the first target group via an account of the current user; otherwise, the first message is sent in the first target group via the chatbot. In some embodiments, in a case that the current user has joined the first target group, the first message is directly sent via the account of the current user, so that the members in the group may know the sender of the message and know that the sender of the message is in the group, without searching for the sender of the message in other groups. Likewise, in a case that the first message is sent via the chatbot, the members in the group may know that the sender of the message is not in the group, without searching for the sender of the message in the group.

In some other embodiments of the disclosure, the first message is sent in the first target group via the chatbot. In some embodiments, the first message is sent in the first target group via the chatbot, which may prevent the potential issue that the current user has no access permission to the first target group.

In some embodiments of the disclosure, an identifier of the current user is displayed in the first message sent via the chatbot. In some embodiments, the identifier of the current user may be a profile photo, a name or a code name of the current user, etc., so that the members in the first target group may know who creates the first message from the identifier of the current user, which may facilitate contacting the current user to know more about the first message.

In some embodiments of the disclosure, the method further comprises: displaying, in response to the first information having a set level, a first flag corresponding to the level of the first information in the first message. In some embodiments, the level may be configured to indicate an importance degree of the first message, e.g., the first message may be flagged as important or not important, where the first flag such as an asterisk may be displayed in an important first message, so that a user viewing the first message may know the level of the first message, thereby giving a particular attention in the case that the first message is an important message.

In some embodiments, the method further comprises: displaying, in response to the target object having a set class, a second flag corresponding to a class of the target object in the first message. In some embodiments of the disclosure, the class may for example be whether an object needs help, and all objects may be classified into objects needing help and objects needing no help. For example, in a case that an object is a project, if the project needs assistance from other members, it may be classified as a project needing help. As such, the members in the first target group would give attention to the object so that the members associated with the object may process it in time.

In some embodiments of the disclosure, the first information is information of the target object, and in response to the first information being a first preset type of information of the target object, a third flag is displayed in the first message. In some embodiments, in a case that the first preset type of information of the target object is created for the first time, indicating that this first message has no message of the same type, the third flag is displayed avoiding the user from searching for the same type of messages of this type from historical messages.

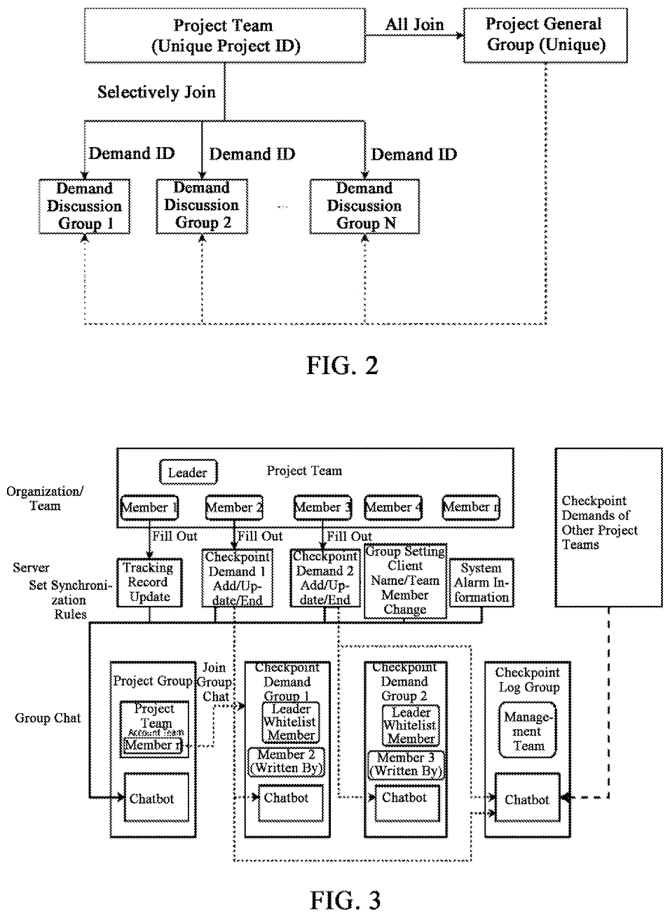

To better illustrate the method provided by the disclosure, a specific example implementation is illustrated infra. Please refer to FIGS. 2 to 4 for the information processing method for information provided in some embodiments of the disclosure, where the first information is inputted in the information input interface for the target object of a mini program. The first information has the first information identifier, the first information identifier including one or more pieces of sub-identifier information. The sub-identifier information for example may be classified as object identifier (project_id), information type identifier (note_id) and user identifier (user_id). One information identifier may include one or more of the three kinds of sub-identifier information. The object identifier is determined based on the target object of the first information, the information type identifier is determined based on the information type of the first information, and the user identifier is determined based on the current user. The target object may be a project, the target object has an object identifier. The project has an associated project general group and at least one demand discussion group. The members of all project teams join the project general group, and part of the members of the project teams may join the demand discussion group. The groups in the set of groups include the project general group and the demand discussion group, as well as other groups such as the checkpoint demand group illustrated in FIG. 3. The groups in the set of groups also have respective group identifiers, each group identifier also including one or more of the three kinds of sub-identifier information noted supra. For example, the project general group in FIG. 2 may establish an association relationship with the project identifier (project_id) as the object identifier, the group identifier and the information identifier based on the sub-identifier information, and the association relationship may be set if the information identifier includes all sub-identifier information in the group identifier or if the information identifier includes a combination of part of the sub-identifier information in the group identifier. As illustrated in FIG. 3, a member of the project team may fill out the first information of the project in the mini program, e.g., a tracking record or checkpoint demand. Upon reception of the first information, the mini program generates a first information identifier of the first information. The mini program may send the first information identifier and the first information to a server, and the server determines the first target group based on the first identifier and then sends the first message to the chatbot of the first target group. The chatbot sends the first message to the first target group. In a case that the first information is a checkpoint demand, the first information identifier includes the object identifier of the target object and the information type identifier characterizing the checkpoint demand type. Therefore, the chatbot sends the checkpoint demand as the first information to the project group where the project team is located based on the object identifier and sends the checkpoint demand to the checkpoint demand group.

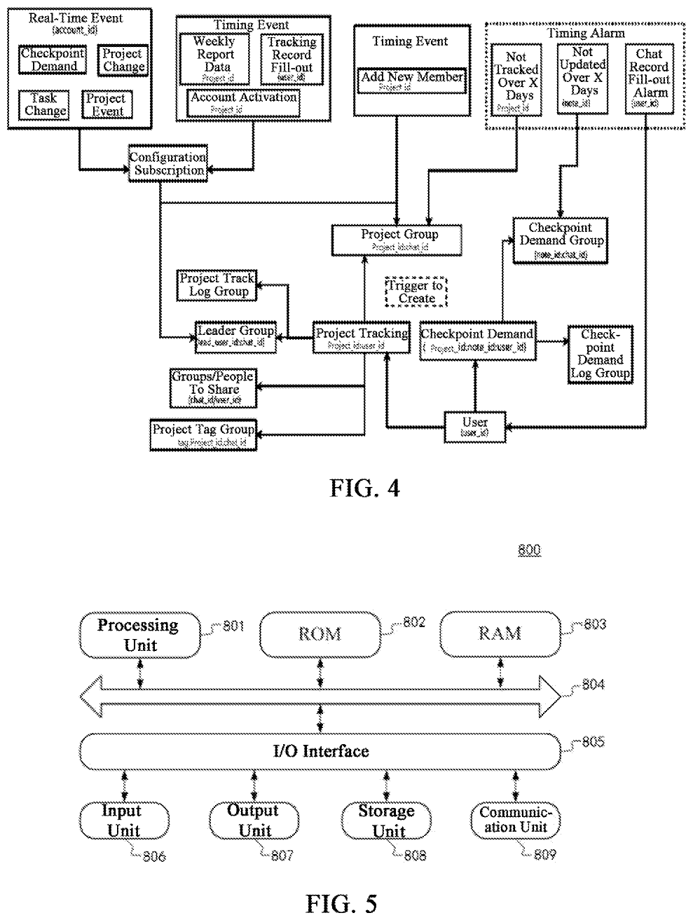

Continuing referring to FIG. 4, different information may have different information identifiers. For example, the information identifier of a tracking event fill-out summary in a timing event includes project_id (object identifier) and user_id (user identifier). After the user sends the tracking event fill-out summary information, it is sent to the project group (the group identifier of the project group includes project_id) based on the project_id, and the Leader group (first group) is determined based on the user_id. The user filling out the tracking record fill-out summary is an associated user of the member of the Leader group. Since the group identifier of the Leader group includes the user_id of the user, the Leader group will receive the message. For another example, when a new member is added, a message of New Member Added is sent. The message identifier of the message includes project_id, therefore, it will be sent to the project group. In addition, with respect to timing alarm, if the project has not been tracked over X days, a message with a message identifier including project_id is generated, which message is sent to the project group. In a case that the checkpoint demand has not been updated over X days, a message with a message identifier including note_id (information type identifier) is generated, which message is sent to a checkpoint demand group with a group identifier including note_id. In a case that a user has not filled out the tracking record over a long term, a piece of alarm information is generated, and the information identifier of the alarm information includes a user_id (user identifier) of the user, so that based on the user_id, the alarm information may be sent to a group with its group identifier including the user_id. As to the project tracking information received in the project tracking group, its information identifier includes project_id and user_id. It may be determined whether to send the project tracking information to the Leader group based on the user_id, and it may be determined whether to send the project tracking information to a project tag group (a third group) based on the tag identifier (tag) of the object corresponding to the project_id.

The method provided according to the embodiments of the disclosure eliminates a need for the user to pre-specify the first target group, and may determine the first target group based on the first information identifier, which facilitate sending of the first information to the first target group without a need for the user to join the first target group.

In some embodiments of the disclosure, there is further provided an information processing apparatus, comprising:
a determining unit configured to determine, in response to first information of a target object inputted by a current user, a first information identifier of the first information based on at least one of the target object, information type of the first information and the current user;
a sending unit configured to send a first message derived based on the first information to at least one first target group, wherein the first target group is determined from among a set of groups based on the first information identifier.

In some embodiments, the determining unit is further configured to determine a second target group associated with the first information;
the sending unit is further configured to send the first message to the second target group.

In some embodiments, determining, by the determining unit, the second target group associated with the first information comprises: determining the second target group based on the first information and/or an input interface where the first information is inputted.

In some embodiments, the second target group is a group bound with the input interface where the first information is inputted; or, the second target group is a group bound with an information type of the first information.

In some embodiments, sending, by the sending unit, the first message derived based on the first information to at least one first target group comprises: sending the first information and the first information identifier to a server, so that the server determines at least one first target group from among the set of groups based on the first information identifier, and sending the first message derived based on the first information to the first target group.

In some embodiments, the current user inputs the first information in an information input interface; the information input interface is an interface other than a communication interface of groups in the set of groups; or, the current user inputs the first information in the communication interface of a group in the set of groups.

In some embodiments, determining, by the determining unit, the first information identifier of the first information based on at least one of the target object, the information type of the first information and the current user comprises:
determining types and number of pieces of sub-identifier information included in the first information identifier based on the information type of the first information, in which the first information identifier includes at least one piece of sub-identifier information;
determining contents of the sub-identifier information included in the first information identifier based on at least one of the target object, the first information type and the current user.

In some embodiments, compositional structures of information identifiers corresponding to different information types of information are preset, the compositional structure includes at least one piece of the sub-identifier information, types of respective pieces of sub-identifier information in one compositional structure are different, compositional structures of information identifiers corresponding to different information types of information are different;
determining the types and the number of pieces of sub-identifier information included in the first information identifier based on the information type of the first information comprises: determining the compositional structure corresponding to the first information identifier based on the information type of the first information, and determining the types and the number of pieces of the sub-identifier information based on the compositional structure corresponding to the first information identifier.

In some embodiments, the first target group is associated with at least one of the target object, the information type of the first information and the current user.

In some embodiments, each group in the set of groups has at least one group identifier bound, and the group identifier bound with the group and the information identifier of information has a mapping relationship; the determining unit determines the first target group based on the first information identifier and the mapping relationship.

In some embodiments, the group identifier includes at least one piece of sub-identifier information, and the information identifier of the information includes at least one of the sub-identifier information; and the mapping relationship is determined based on the sub-identifier information of the group identifier and the sub-identifier information included in the information identifier.

In some embodiments, one information identifier and one or at least two group identifiers of groups have a mapping relationship; and/or, the group identifier of one of the groups and one or at least two information identifiers have a mapping relationship.

In some embodiments, the group identifier bound with the group includes a user identifier, and the information identifier includes the user identifier; the set of groups include a first group, and at least one member in the first group has an associated member; and the group identifier of the first group includes a user identifier of the associated member, and in a case that the first information identifier includes the user identifier of the associated member, the first target group includes the first group.

In some embodiments, the at least one member is a superior to the associated member, and the associated member is a subordinate to the at least one member; and the at least one member and the associated member are associated via a superior-subordinate relationship.

In some embodiments, the group identifier bound with the group includes an object identifier and an information type identifier, and the information identifier includes an object identifier and an information type identifier;
the set of groups includes a second group, and a group identifier of the second group includes: an information type identifier and at least two object identifiers. In a case that the first information identifier includes an information type identifier in the group identifier of the second group and the first information identifier includes at least one object identifier in the group identifier of the second group, the first target group includes the second group.

In some embodiments, the group identifier bound with the group includes a tag identifier, and the information identifier includes the tag identifier. The target object has a corresponding tag, and the first information identifier includes the tag identifier generated based on the tag of the target object. The set of groups includes a third group, and the group identifier of the third group includes a tag identifier. In a case that the first information identifier includes the tag identifier in the group identifier of the third group, the first target group includes the third group.

In some embodiments, one object has at least one tag, and/or objects of a same type has a common tag.

In some embodiments, the first message includes an entry control for joining the second target group.

In some embodiments, the information processing apparatus further comprises a sharing unit configured to determine, in response to a sharing operation, a sharing target object, and send the first message to the sharing target object.

In some embodiments, in a case that the input interface where the first information is inputted is a communication interface of a group in the set of groups, a control device is configured to control a chatbot joining the group in the set of groups to perform a control step. In some embodiments, in a case that the input interface where the first information is inputted is a page of the target object displayed in a mini program, a control device controls the mini program to perform the step of determining the first information identifier of the first information based on at least one of the target object, information type of the first information and the current user, and the mini program sends the first message to the first target group via the chatbot of the group in the set of groups.

In some embodiments, if the current user inputting the first information has joined the first target group, the first message is sent in the first target group via an account of the current user; otherwise, the first message is sent in the first target group via the chatbot.

In some embodiments, the first message is sent in the first target group via the chatbot.

In some embodiments, an identifier of the current user is displayed in the first message sent via the chatbot.

In some embodiments, the determining unit is further configured to display, in response to the first information having a set level, in the first message a first flag corresponding to the level of the first information; and/or,
display, in response to the target object having a set class, in the first message a second flag corresponding to the class of the target object; and/or,
in a case that the first information is information of a target object, display, in response to the first information being a first preset type of information of the target object, in the first message a third flag.

In some embodiments, the first information is project-related information, and the information type of the first information is a project tracking record, a project demand, or a project report; or, the first information is task-related information, and the information type of the first information is a task progress, a task objective, or a task report.

Since the apparatus embodiments substantially correspond to the method embodiments, relevant features of the apparatus embodiments may refer to the depictions of the method embodiments. The apparatus embodiments described supra are only schematic, and those modules illustrated as discrete modules may be or may not be separate. Some or all of the modules may be selected to implement the solutions of the embodiments of the disclosure dependent on actual needs. A person of normal skill in the art may understand and implement the apparatus embodiments without exercise of inventive work.

The methods and apparatuses of the disclosure have been illustrated above via embodiments and application examples. In addition, the disclosure further provides a terminal and a storage medium, which will be described infra.

Hereinafter, referring to FIG. 5, which illustrates a structural schematic diagram of an electronic device 800 (the electronic device for example may be a terminal device or a server, where the terminal device may also be referred to as a terminal) adapted to implement the embodiments of the disclosure. The terminal device referred to in the embodiments of the disclosure may include, but is not limited to, a mobile terminal such as a mobile phone, a laptop device, a digital broadcast receiver, a PDA (Personal Digital Assistant), a PAD (Tablet), a PMP (Portable Media Player), or a vehicle-mounted terminal (e.g., a vehicle-mounted navigation terminal), and a fixed terminal such as a digital TV or a table computer. The electronic device illustrated herein is only exemplary, which should not constitute any limitation to the functions and scope of use of the embodiments of the disclosure.

The electronic device 800 may comprise a processing unit (e.g., a Center Processing Unit, a Graphic Processing Unit, etc.) 801, which may execute various suitable actions and processing based on the program stored in a read-only memory (ROM) 802 or a program loaded in the random-access memory (RAM) 803 from a storage unit 808. The RAM 803 can also store all kinds of programs and data necessary to operation of the electronic device 800. The processing device 801, ROM 802 and RAM 803 are interconnected to each other via a bus 804. The input/output (I/O) interface 805 is also connected to the bus 804.

Generally, the following devices may be connected to the I/O interface 805: an input unit 806 including, e.g., a touch screen, a touch pad, a keypad, a mouse, a camera, a microphone, an accelerometer, or a gyroscope; an output unit 807, e.g., a LCD (Liquid Crystal Display), a loudspeaker, or a vibrator; a storage unit 808 such as a magnetic tape, a hard disk; and a communication unit 809. The communication unit 809 allows the electronic device 800 to exchange information/data with other devices via wireless or cable communication. Although the electronic device 800 comprising various components is shown in the figure, it is understood that it is not required to implement or possess all of the illustrated components. Alternatively, more or less components may be implemented or possessed.

Particularly, according to the embodiments of the disclosure, the processes described with reference to the above flow diagram may be implemented as computer software programs. For example, embodiments of the disclosure comprise a computer program product comprising a computer program carried on the computer-readable medium, the computer program including program codes for performing the methods illustrated in the flow diagram. In such embodiments, the computer program may be downloaded and installed from the network via the communication unit 809, or installed from the storage unit 808, or installed from the ROM 802. When the computer program is executed by the processing unit 801, the actions defined by the methods according to the embodiments of the disclosure are implemented.

It is noted that, the computer-readable medium described supra may be a computer-readable signal medium or a computer-readable storage medium or any combination of the above. The computer-readable storage medium for example may be, but is not limited to, electric, magnetic, optical, electro-magnetic, infrared or semiconductor system, apparatus or device, or any combination thereof. More specific examples of the computer-readable storage medium include, but are not limited to, an electric connection via one or more wires, a portable computer magnetic disk, hard disk, random access memory (RAM), read-only memory (ROM), erasable programmable read-only memory (EPROM or flash memory), optical fiber, portable compact-disc read-only storage medium (CD-ROM), optical storage device, magnetic storage device, or any appropriate combination thereof. In the disclosure, the computer-readable storage medium may refer to any tangible medium including or storing a program that can be used by an instruction executing system, apparatus or device or used by a combination thereof. However, in the disclosure, the computer-readable signal medium may include data signals in the base band or propagated as a part of carrier, in which the computer-readable program codes are carried. This propagated data signals may take on various forms, including, but not limited to, electromagnetic signals, optical signals, or any suitable combination thereof. The computer-readable signal medium may also be any computer-readable medium other than the computer-readable storage medium, which computer-readable signal medium may transmit, propagate, or transfer a program used by the instruction executing system, apparatus or device, or used in combination therewith. The program code stored on the computer-readable medium may be transmitted via any appropriate medium including, but is not limited to, wires, cables, RFs (Radio Frequencies), etc., or any appropriate combination thereof.

In some embodiments, the client and the server may communicate using any currently known or future developed network protocols such as HTTP (HyperText Transfer Protocol), and may be interconnected with a digital data communication (e.g., communication network) of any form or medium. Examples of the communication network include a local area network (“LAN”), a wide area network (“WAN”), a network of networks (e.g., the Internet), and a peer-to-peer network (e.g., an ad hoc peer-to-peer network), and any currently known or future developed network.

The computer-readable medium may be included in the electronic device, or may be standalone, without being installed in the electronic device.

The computer-readable medium carries one or more programs; when the one or more programs are executed by the electronic device, the electronic device performs the methods of the disclosure.

The computer-program code for performing the operations of the disclosure may be compiled with one or more programming languages or a combination thereof, the programming languages comprise object-oriented programming languages, e.g., Java, Smalltalk, C++, and further comprise traditional procedural programming languages, such as “C” language or similar programming languages. The program codes can be executed completely on the user computer, partially on the user computer, as an independent software package, partially on the user computer and partially on the remote computer, or completely on the remote computer or server. In a scenario where a remote computer is involved, the remote computer can be connected to the user computer via any type of network, including local area network (LAN) and wide area network (WAN), or to the external computer (e.g., connected via Internet using the Internet service provider).

The flow diagrams and block diagrams in the drawings illustrate system architecture, functions and operations that may be implemented by the system, method and computer program product according to various embodiments of the disclosure. In this regard, each block in the flow diagram or block diagram can represent a module, a program snippet, or a part of code, wherein the module, the program snippet, or the part of code includes one or more executable instructions for performing specified logic functions. It is also noted that, in some alternative implementations, the functions indicated in the blocks can also occur in an order different from those indicated in the drawings. For example, two successively represented blocks can be actually executed in parallel and sometimes in a reverse order dependent on the concerned functions. It is also noted that, each block in the block diagram and/or flow diagram and a combination of the blocks in the block diagram and/or flow diagram may be implemented by a dedicated hardware-based system for executing specified functions or actions, or implemented by a combination of dedicated hardware and computer instructions.

The units described in the embodiments of the disclosure may be implemented in a software manner or in a hardware manner, wherein the names of the units do not constitute limitation to the unit per se in some circumstances.

The functions described herein may be executed at least partially by one or more hardware logic components. For example, an example hardware logic component that may be used includes, but is not limited to, a field programmable gate array (FPGA), an application-specific integrated circuit (ASIC), an application-specific standard product (ASSP), a system-on-chip (SOC), and a complex programmable logic device (CPLD), etc.

Within the context of the present disclosure, the machine-readable medium may be any tangible medium including or storing programs for or related to the instruction execution system, apparatus, or device. The machine readable medium may include, but is not limited to, electronic, magnetic, optical, electro-magnetic, infrared or semiconductor system, apparatus or device, or any combination thereof. More specific examples of the machine-readable storage medium include an electric connection via one or more wires, a portable computer magnetic disk, a hard disk, a random access memory (RAM), a read-only memory (ROM), an erasable programmable read-only memory (EPROM or flash memory), an optical storage device, a magnetic storage device, or any appropriate combination thereof.

According to one or more embodiments of the disclosure, [example 1] provides an information processing method, comprising: determining, in response to first information of a target object inputted by a current user, a first information identifier of the first information based on at least one of the target object, information type of the first information and the current user; and
sending a first message derived based on the first information to at least one first target group;
wherein the first target group is a group determined from among a set of groups based on the first information identifier.

According to one or more embodiments of the disclosure, [example 2] provides the method of [example 1], further comprising: determining a second target group associated with the first information; and
sending the first message to the second target group.

According to one or more embodiments of the disclosure, [example 3] provides the method of [example 2], in which determining the second target group associated with the first information comprises: determining the second target group based on at least one of the first information and/or an input interface where the first information is inputted.

According to one or more embodiments of the disclosure, [example 4] provides the method of [example 3], in which the second target group is a group bound with the input interface where the first information is inputted; or,
the second target group is a group bound with the information type of the first information.

According to one or more embodiments of the disclosure, [example 5] provides the method of [example 1], in which sending the first message derived based on the first information to at least one first target group comprises:
sending the first information and the first information identifier to a server, so that the server determines at least one first target group from among the set of groups based on the first information identifier and sends the first message derived based on the first information to the first target group.

According to one or more embodiments of the disclosure, [example 6] provides the method of [example 1], in which the current user inputs the first information in an information input interface; the information input interface is an interface other than a communication interface of groups in the set of groups; or,
the current user inputs the first information in a communication interface of a group in the set of groups.

According to one or more embodiments of the disclosure, [example 7] provides the method of [example 1], in which determining the first information identifier of the first information based on at least one of the target object, information type of the first information, and the current user comprises:
determining types and number of pieces of sub-identifier information included in the first information identifier based on the information type of the first information, wherein the first information identifier includes at least one piece of sub-identifier information; and
determining contents of the sub-identifier information in the first information identifier based on at least one of the target object, the information type of the first information and the current user.

According to one or more embodiments of the disclosure, [example 8] provides the method of [example 7], in which compositional structures of information identifiers corresponding to different information types of information are preset, wherein each of the compositional structures includes at least one piece of the sub-identifier information, types of respective sub-identifier information in one compositional structure are different, and compositional structures of information identifiers corresponding to different information types of information are different;
determining the types and the number of pieces of sub-identifier information included in the first information identifier based on the information type of the first information comprises: determining a compositional structure corresponding to the first information identifier based on information type of the first information, and determining the types and the number of pieces of the sub-identifier information based on the compositional structure corresponding to the first information identifier.

According to one or more embodiments of the disclosure, [example 9] provides the method of [example 1], in which the first target group is associated with at least one of the target object, the information type of the first information, and the current user.

According to one or more embodiments of the disclosure, [example 10] provides the method of [example 1], in which a group in the set of groups has at least one group identifier bound, and the group identifier bound with the group has a mapping relationship with an information identifier of information; and
determining the first target group based on the first information identifier and the mapping relationship.

According to one or more embodiments of the disclosure, [example 11] provides the method of [example 10], in which the group identifier includes at least one piece of sub-identifier information, and the information identifier of the information includes at least one piece of the sub-identifier information; and
the mapping relationship is determined based on the sub-identifier information of the group identifier and the sub-identifier information included in the information identifier.

According to one or more embodiments of the disclosure, [example 12] provides the method of [example 10], in which one information identifier has a mapping relationship with one or at least two group identifiers of groups; and/or the group identifier of one group has a mapping relationship with one or at least two information identifiers.

According to one or more embodiments of the disclosure, [example 13] provides the method of [example 10], in which the group identifier bound with the group includes a user identifier, and the information identifier includes the user identifier; and
the set of groups includes a first group, and at least one member in the first group has an associated member; a group identifier of the first group includes a user identifier of the associated member, and in a case that the first information identifier includes the user identifier of the associated member, the first target group includes the first group.

According to one or more embodiments of the disclosure, [example 14] provides the method of [example 13], in which the at least one member is a superior to the associated member, and the associated member is a subordinate to the at least one member; and the at least one member and the associated member are associated via a superior-subordinate relationship.

According to one or more embodiments of the disclosure, [example 15] provides the method of [example 10], in which the group identifier bound with the group includes an object identifier and an information type identifier, and the information identifier includes an object identifier and an information type identifier; and
the set of groups include a second group, and a group identifier of the second group includes an information type identifier and at least two object identifiers; and in a case that the first information identifier includes an information type identifier in the group identifier of the second group and the first information identifier includes at least one object identifier included in the group identifier of the second group, the first target group includes the second group.

According to one or more embodiments of the disclosure, [example 16] provides the method of [example 10], in which the group identifier bound with the group includes a tag identifier, and the information identifier includes the tag identifier;
the target object has a corresponding tag, the first information identifier includes a tag identifier generated based on the tag of the target object, the set of groups includes a third group, and a group identifier of the third group includes a tag identifier; and in a case that the first information identifier includes the tag identifier included in the group identifier of the third group, the first target group includes the third group.

According to one or more embodiments of the disclosure, [example 17] provides the method of [example 16], in which one object has at least one tag; and/or objects of same type have a common tag.

According to one or more embodiments of the disclosure, [example 18] provides the method of [example 2], in which the first message includes an entry control for joining the second target group.

According to one or more embodiments of the disclosure, [example 19] provides the method of [example 1], in which the method further comprises: determining, in response to a sharing operation, a sharing target object, and sending the first message to the sharing target object.

According to one or more embodiments of the disclosure, [example 20] provides the method of [example 1], in which in a case that an input interface where the first information is inputted is a communication interface of a group in the set of groups, the method is performed by a chatbot joining the group in the set of groups; or,
in a case that the input interface where the first information is inputted is a page of the target object displayed in a mini program, the mini program performs the determining a first information identifier of the first information based on at least one of the target object, information type of the first information, and the current user, and the mini program sends the first message to the first target group via the chatbot joining the group in the set of groups.

According to one or more embodiments of the disclosure, [example 21] provides the method of [example 1], in which in a case that the current user inputting the first information has joined the first target group, the first message is sent in the first target group via an account of the current user; otherwise, the first message is sent in the first target group via a chatbot;
or, the first message is sent in the first target group via the chatbot.

According to one or more embodiments of the disclosure, [example 22] provides the method of [example 21], in which an identifier of the current user is displayed in the first message sent via the chatbot.

According to one or more embodiments of the disclosure, [example 23] provides the method of [example 1], in which the method further comprises at least one of: displaying, in response to the first information having a set level, in the first message a first flag corresponding to the level of the first information;
displaying, in response to the target object having a set class, in the first message a second flag corresponding to the class of the target object; and
the first information is information of the target object, and in response to the first information being a first preset type of information of the target object, displaying in the first message a third flag.

According to one or more embodiments of the disclosure, [example 24] provides the method of [example 1], in which the first information is project-related information, and the information type of the first information is a project tracking record, a project demand or a project report; or, the first information is task-related information, and the information type of the first information is a task progress, a task objective or a task report.

According to one or more embodiments of the disclosure, [example 25] provides an information processing apparatus, comprising:
a determining unit configured to determine, in response to first information of a target object inputted by a current user, a first information identifier of the first information based on at least one of the target object, information type of the first information and the current user; and
a sending unit configured to send a first message derived based on the first information to at least one first target group;
wherein the first target group is a group determined based on the first information identifier from among a set of groups.

According to one or more embodiments of the disclosure, [example 26] provides a terminal, comprising:
at least one memory and at least one processor;
wherein the at least one memory stores program codes, and the at least one processor is configured to invoke the program codes stored on the at least one memory to perform the method according to any of [example 1] to [example 24].

According to one or more embodiments of the disclosure, [example 27] provides a computer-readable storage medium having program codes stored thereon which, when executed by a computer, cause the computer to perform the method according to any of [example 1] to [example 24].

What have been described above are only illustrations of the preferred embodiments of the disclosure and the technical principles applied thereby. Those skilled in the art should understand that the scope of the disclosure herein is not limited to a technical solution formed by specific combinations of the technical features described supra, which should also encompass other technical solutions formed by any combination of the above technical features or equivalent features without departing from the idea described supra, e.g., a technical solution formed by mutual substitution between the above features and the technical features with similar functions as disclosed (but not limited to) herein.

In addition, although various operations are described in a specific order, it should not be construed such that these operations must be performed in the specific order as illustrated or in a sequential order. In certain circumstances, multi-task parallel processing can be advantageous. Likewise, although a plurality of specific implementation details have been described supra, these details should not be construed as limiting the scope of the disclosure. Some features described within the context of individual embodiments may also be combined to be implemented in a single embodiment. In turn, various features described within the context of a single embodiment may also be implemented in a plurality of embodiments separately or in any appropriate sub-combination manner.

Although the subject matter has been described with languages specific to structural features and/or method logic actions, it would be understood that the subject matter limited in the appended claims is not necessarily limited to the specific features or actions described supra. On the contrary, the specific features and actions described supra are only exemplary forms of implementing the claims.

1. An information processing method, comprising:
determining, in response to first information of a target object inputted by a current user, a first information identifier of the first information based on at least one of the target object, information type of the first information and the current user; and
sending a first message derived based on the first information to at least one first target group;
wherein the first target group is a group determined from among a set of groups based on the first information identifier.

2. The method of claim 1, further comprising:
determining a second target group associated with the first information; and
sending the first message to the second target group.

3. The method of claim 2, wherein determining the second target group associated with the first information comprises: determining the second target group based on at least one of the first information and/or an input interface where the first information is inputted.

4. (canceled)

5. The method of claim 1, wherein sending the first message derived based on the first information to at least one first target group comprises:
sending the first information and the first information identifier to a server, so that the server determines the at least one first target group from among the set of groups based on the first information identifier and sends the first message derived based on the first information to the first target group.

6. The method of claim 1, wherein
the current user inputs the first information in an information input interface; the information input interface is an interface other than communication interfaces of groups in the set of groups; or
the current user inputs the first information in a communication interface of a group in the set of groups.

7. The method of claim 1, wherein determining the first information identifier of the first information based on at least one of the target object, information type of the first information and the current user comprises:
determining types and number of pieces of sub-identifier information included in the first information identifier based on the information type of the first information, wherein the first information identifier includes at least one piece of sub-identifier information; and
determining contents of the sub-identifier information in the first information identifier based on at least one of the target object, the information type of the first information and the current user.

8. (canceled)

9. The method of claim 1, wherein
the first target group is associated with at least one of the target object, the information type of the first information and the current user.

10. The method of claim 1, wherein
a group in the set of groups has at least one group identifier bound, and the group identifier bound with the group has a mapping relationship with an information identifier of information; and
determining the first target group based on the first information identifier and the mapping relationship.

11. The method of claim 10, wherein
the group identifier includes at least one piece of sub-identifier information, and the information identifier of the information includes at least one piece of the sub-identifier information; and
the mapping relationship is determined based on the sub-identifier information of the group identifier and the sub-identifier information included in the information identifier.

12. The method of claim 10, wherein
one information identifier has a mapping relationship with one or at least two group identifiers of groups; and/or
the group identifier of one group has a mapping relationship with one or at least two information identifiers.

13-15. (canceled)

16. The method of claim 10, wherein
the group identifier bound with the group includes a tag identifier, and the information identifier includes the tag identifier; and
the target object has a corresponding tag, the first information identifier includes a tag identifier generated based on the tag of the target object, the set of groups includes a third group, and a group identifier of the third group includes a tag identifier; and in a case that the first information identifier includes the tag identifier included in the group identifier of the third group, the first target group includes the third group.

17. (canceled)

18. The method of claim 2, wherein
the first message includes an entry control for joining the second target group.

19. The method of claim 1, further comprising:
determining, in response to a sharing operation, a sharing target object, and sending the first message to the sharing target object.

20. The method of claim 1, wherein
in a case that an input interface where the first information is inputted is a communication interface of a group in the set of groups, the method is performed by a chatbot joining the group in the set of groups; or
in a case that the input interface where the first information is inputted is a page of the target object displayed in a mini program, the mini program performs the determining a first information identifier of the first information based on at least one of the target object, information type of the first information and the current user, and the mini program sends the first message to the first target group via the chatbot joining the group in the set of groups.

21. The method of claim 1, wherein
in a case that the current user inputting the first information has joined the first target group, the first message is sent in the first target group via an account of the current user, otherwise, the first message is sent in the first target group via a chatbot;
or
the first message is sent in the first target group via the chatbot.

22. The method of claim 21, wherein
an identifier of the current user is displayed in the first message sent via the chatbot.

23. The method of claim 1, further comprising at least one of
displaying, in response to the first information having a set level, in the first message a first flag corresponding to the level of the first information;
displaying, in response to the target object having a set class, in the first message a second flag corresponding to the class of the target object; and
the first information being information of the target object, and in response to the first information being a first preset type of information of the target object, displaying in the first message a third flag.

24. The method of claim 1, wherein
the first information is project-related information, and the information type of the first information is a project tracking record, a project demand or a project report; or
the first information is task-related information, and the information type of the first information is a task progress, a task objective or a task report.

25. (canceled)

26. An electronic device, comprising:
at least one memory and at least one processor;
wherein the at least one memory stores program codes that, in response to execution by the at least one processor, cause the electronic device to:
determine, in response to first information of a target object inputted by a current user, a first information identifier of the first information based on at least one of the target object, information type of the first information and the current user; and
send a first message derived based on the first information to at least one first target group;
wherein the first target group is a group determined from among a set of groups based on the first information identifier.

27. A non-transitory computer-readable storage medium having program codes stored thereon which, when executed by a computer, cause the computer to:
determine, in response to first information of a target object inputted by a current user, a first information identifier of the first information based on at least one of the target object, information type of the first information and the current user; and
send a first message derived based on the first information to at least one first target group;
wherein the first target group is a group determined from among a set of groups based on the first information identifier.
